(19) United States
(12) Patent Application Publication
(10) Pub. No.: US 2023/0117647 A1
(43) Pub. Date: Apr. 20, 2023

(54) RAINBOW FREE WAVEGUIDE COMBINER

(71) Applicant: Applied Materials, Inc., Santa Clara, CA (US)

(72) Inventors: Kevin MESSER, Mountain View, CA (US); David SELL, Santa Clara, CA (US); Samarth BHARGAVA, Saratoga, CA (US)

(21) Appl. No.: 17/949,292

(22) Filed: Sep. 21, 2022

Related U.S. Application Data
(60) Provisional application No. 63/256,083, filed on Oct. 15, 2021.

(51) Int. Cl. G02B 27/01; F21V 8/00; G02B 5/18; G02B 27/10; G02B 6/34

(52) U.S. Cl. CPC G02B 27/0172; G02B 6/0016; G02B 5/1847; G02B 27/1086; G02B 6/34; G02B 2027/0178; G02B 2027/0118

(57) ABSTRACT

A rainbow-free waveguide display, a near-eye display incorporating the rainbow-free waveguide, and methods of manufacturing the rainbow-free waveguide are provided. The display includes a waveguide display configured to direct image light to an eyebox plane having a length (L_{Eyebox}) and to a user's eye. The waveguide display includes a waveguide combiner and an out-coupler grating, wherein the out-coupler grating has a grating period Λ_{OC} such that all angles of incidence θᵢₙ of light from an external light source, result in diffracted angles θₒᵤₜ, that miss the user's eye.

### CROSS-REFERENCE TO RELATED APPLICATIONS

This application claims the benefit of U.S. Provisional Patent Application Ser. No. 63/256,083, filed Oct. 15, 2021, which is incorporated by reference herein in its entirety.

### TECHNICAL FIELD

Embodiments described herein generally relate to near-eye display systems, and more specifically to near-eye display systems with reduced rainbow artifacts and methods of forming the same.

### BACKGROUND

Virtual reality (VR) is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality (AR), however, enables an experience in which a user can still see through the display lenses of the glasses or other HMD device to view the surrounding environment, yet also see images of virtual objects that are generated for display and appear as part of the environment. AR can include any type of input, such as audio and haptic inputs, as well as virtual images, graphics, and video that enhance or augment the environment that the user experiences. As an emerging technology, there are many challenges and design constraints with augmented reality.

Typical diffractive near-eye display systems suffer from external light source diffraction, for example, a rainbow artifact, which results in the appearance of a rainbow streak of light in the user's field of view (FoV). This rainbow artifact is an unwanted diffraction to the user experience in an AR display system.

Accordingly, what is needed in the art are near-eye display systems with reduced rainbow artifact.

### SUMMARY

Embodiments described herein generally relate to near-eye display systems, and more specifically to near-eye display systems with reduced rainbow artifacts and methods of forming the same.

In one aspect, a method of manufacturing a rainbow-free waveguide display is provided. The method includes manufacturing a waveguide display assembly configured to direct image light to an eyebox plane having a length (L_{Eyebox}) and to a user's eye. The waveguide display assembly includes a waveguide combiner and an out-coupler grating. The out-coupler grating has a grating period Λ_{OC} such that all angles of incidence θᵢₙ of light from an external light source, result in diffracted angles Bₒᵤₜ, that miss the user's eye by satisfying the following first order diffraction equation (I):

$$sin ( {θ}_{o u t} ) = sin ( {θ}_{i n} ) + / - \frac{λ}{{Λ}_{OC}} \qquad ( I )$$

wherein λ is the wavelength of the light from the external light source.

In another aspect, a waveguide display is provided. The waveguide display is configured to direct image light to an eyebox plane having a length (L_{Eyebox}) and to a user's eye. The waveguide display includes waveguide combiner and an out-coupler grating. The out-coupler grating has a grating period

Λ_{OC} such that all angles of incidence θᵢₙ of light from an external light source, result in diffracted angles Bₒᵤₜ, that miss the user's eye by satisfying the following first order diffraction equation (I):

$$sin ( {θ}_{o u t} ) = sin ( {θ}_{i n} ) + / - \frac{λ}{{Λ}_{OC}}$$

wherein λ is the wavelength of the light from the external light source.

In yet another aspect, a near-eye display is provided. The near-eye display includes a frame and a display. The display includes a waveguide display configured to direct image light to an eyebox plane having a length (L_{Eyebox}) and to a user's eye. The waveguide display includes a waveguide combiner and an out-coupler grating, wherein the out-coupler grating has a grating period Λ_{OC} such that all angles of incidence θᵢₙ of light from an external light source, result in diffracted angles Bₒᵤₜ, that miss the user's eye by satisfying the following first order diffraction equation (I):

$$sin ( {θ}_{o u t} ) = sin ( {θ}_{i n} ) + / - \frac{λ}{{Λ}_{OC}} \qquad ( I )$$

wherein λ is the wavelength of the light from the external light source.

In another aspect, a non-transitory computer readable medium has stored thereon instructions, which, when executed by a processor, causes the process to perform operations of the above apparatus and/or method.

### BRIEF DESCRIPTION OF THE DRAWINGS

So that the manner in which the above-recited features of the present disclosure can be understood in detail, a more particular description of the implementations, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a perspective view of a near-eye display system according to one or more embodiments of the present disclosure.

FIG. 2 illustrates a cross-sectional view of the near-eye display system of FIG. 1 according to one or more embodiments of the present disclosure.

FIG. 3 illustrates a cross-sectional view of a waveguide display according to one or more embodiments of the present disclosure.

FIG. 4A illustrates a K-Space diagram of a grating vector architecture according to one or more embodiments of the present disclosure.

FIG. 4B illustrates a K-Space diagram of the grating vector architecture of FIG. 4A including the path of rainbow artifact light.

FIG. 5 illustrates a flow chart of a method for determining system design parameters for a rainbow-free near-eye display system according to one or more embodiments of the present disclosure.

FIG. 6 illustrates various design parameters used in the method depicted by the flow chart of FIG. 5 according to one or more embodiments of the present disclosure.

FIG. 7 illustrates various design parameters used in the method depicted by the flow chart of FIG. 5 according to one or more embodiments of the present disclosure.

FIG. 8 illustrates various design parameters used in the method depicted by the flow chart of FIG. 5 according to one or more embodiments of the present disclosure.

FIG. 9 illustrates a plot depicting Maximum Field of View (°) versus Substrate Refractive Index according to one or more embodiments of the present disclosure.

To facilitate understanding, identical reference numerals have been used, where possible, to designate identical elements that are common to the figures. It is contemplated that elements and features of one implementation may be beneficially incorporated in other implementations without further recitation.

### DETAILED DESCRIPTION

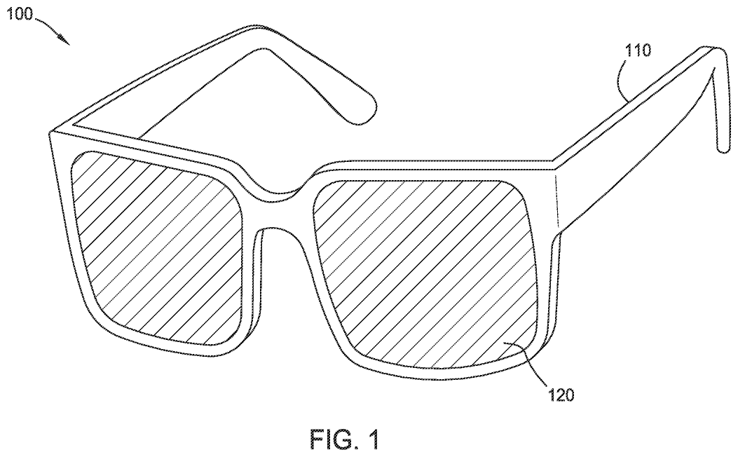

The following disclosure generally describes display systems for virtual reality and augmented reality. Certain details are set forth in the following description and in FIGS. 1-9 to provide a thorough understanding of various implementations of the disclosure. Other details describing well-known structures and systems often associated with display systems for virtual reality and augmented reality are not set forth in the following disclosure to avoid unnecessarily obscuring the description of the various implementations.

Many of the details, dimensions, angles and other features shown in the Figures are merely illustrative of particular implementations. Accordingly, other implementations can have other details, components, dimensions, angles and features without departing from the spirit or scope of the present disclosure. In addition, further implementations of the disclosure can be practiced without several of the details described below.

Embodiments described herein generally relate to near-eye display systems, and more specifically to near-eye display systems with reduced rainbow artifacts and methods of forming the same. The near-eye-display system utilizes a diffractive waveguide combiner layer designed to prevent light sources from the external world from diffracting into the user's eye (commonly referred to as a rainbow artifact). A set of relationships and constraints on the waveguide combiner and optical system design are provided to ensure that no rainbow artifacts can reach the user's eye in normal operation.

Typical diffractive near-eye displays suffer from external light source diffraction (rainbow artifact), which results in the appearance of a rainbow streak of light in the user's field-of-view. Such external sources include room lights and the sun. This rainbow artifact is an unwanted distraction to the user experience in an augmented reality display system.

Current near-eye display designs either live with the issue, mitigate the issue with complex grating structures, use external films to mitigate the issue, or use visor-like mechanical features to block the undesirable light paths. In contrast, in some embodiments of the present disclosure, rainbow artifacts are eliminated by utilizing out-coupler grating periods, which do not allow diffracted orders from external light sources to reach the user's eye.

By utilizing the design relationships and constraints outlined in the present disclosure, this display system described herein does not suffer from external light source diffraction (“rainbow” artifact), in the user's field-of-view. Unlike other approaches to mitigating this artifact, some embodiments described herein do not use any external device or layers to filter the light from sources in the world which is incident on the waveguide-combiner. Additionally, some embodiments described herein do not use any visor-like mechanical blockages that extend beyond the plane of the waveguide combiner to prevent light paths that generate “rainbow” artifacts from hitting the waveguide combiner.

The appearance of rainbow artifacts is dependent on the spectrum of the light sources that generate them, as well as the location of the user's eye pupil. In order to provide a quantitative definition of “rainbow” free, a minimum wavelength of 450nm is used for the source spectrum, and it is assumes that the user's pupil is located at the nominal eye position (center) of the designed eyebox plane at the intended eye relief of the waveguide combiner display system. With this definition, the only possible rainbow artifacts that could possibly be viewed will be very blue/violet (due to the 450nm cutoff in the assumption) where human sensitivity is very low, and will be located over a small angular extent near the edges of the out-coupling grating region.

FIG. 1 illustrates a perspective view of a near-eye display system 100 according to one or more embodiments of the present disclosure. The near-eye display system 100 can present media to a user. Examples of media presented by the near-eye display system 100 can include one or more images, video, and/or audio. In one embodiment, which can be combined with other embodiments, audio may be presented via an external device (e.g., speakers and/or headphones) that receives audio information from the near-eye display system 100, a console, or both, and presents audio data based on the audio information. The near-eye display system 100 is generally configured to operate as an artificial reality display. In one embodiment, which can be combined with other embodiments, the near-eye display system 100 can operate as an augmented reality (AR) display.

The near-eye display system 100 can include a frame 110 and a display 120. The frame 110 can be coupled to one or more optical elements. The display 120 can be configured for the user to see content presented by the near-eye display system 100. In one embodiment, which can be combined with other embodiments, the display 120 can include a waveguide display assembly for directing light from one or more images to an eye of the user.

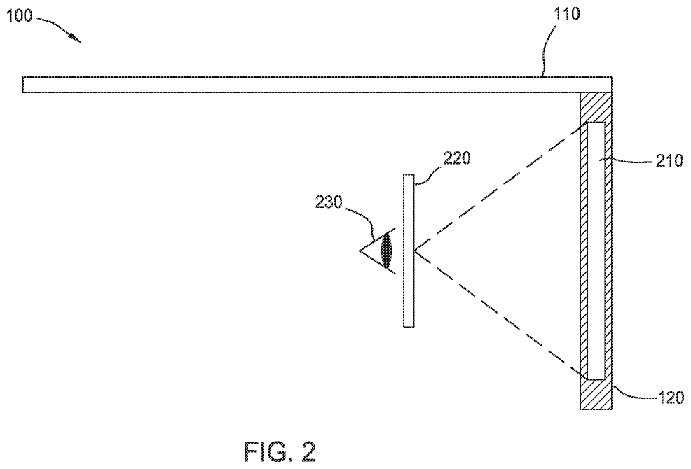

FIG. 2 illustrates a cross-sectional view of the near-eye display system 100 of FIG. 1 according to one or more embodiments of the present disclosure. The near-eye display system 100 can include at least one waveguide display assembly 210. The waveguide display assembly 210 is configured to direct image light, for example display light, to an eyebox plane 220 defining an eyebox plane and then to a user's eye 230. The waveguide display assembly 210 can include one or more materials with one or more refractive indices. In one embodiment, which can be combined with other embodiments, the near-eye display system 100 can include one or more optical elements between the waveguide display assembly 210 and the user's eye 230.

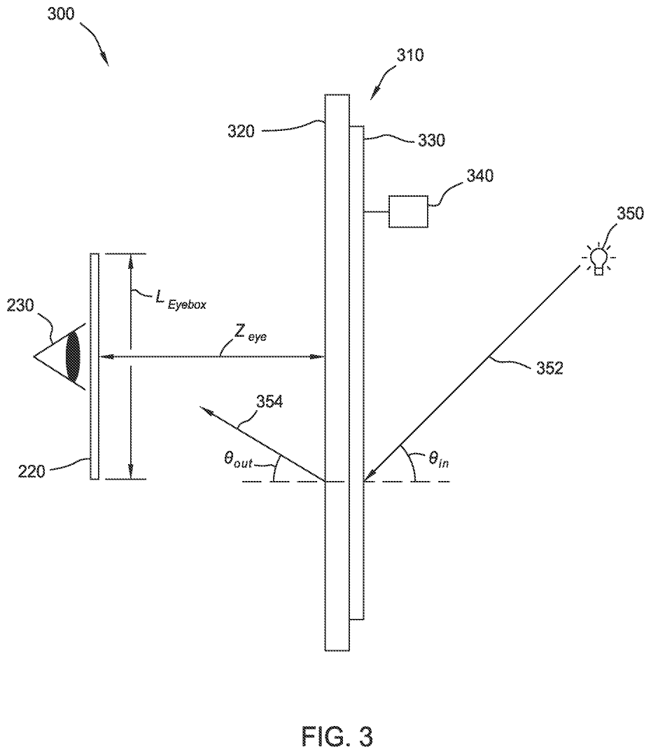

FIG. 3 illustrates a cross-sectional view of a waveguide display 300 according to one or more embodiments of the present disclosure. FIG. 3 illustrates rainbow artifacts in the waveguide display 300. The waveguide display 300 includes a waveguide display assembly 310. The waveguide display assembly 310 includes a waveguide combiner 320 and an out-coupler grating 330. The waveguide display 300 can further include a projector 340. Display light from the projector 340 can be coupled into the waveguide combiner 320 and can be partially coupled out of the waveguide combiner 320 at different locations by the out-coupler grating 330 to reach the user's eye 230. External light 352 from an external light source 350, for example, the sun or a lamp, can also be diffracted by the out-coupler grating 330 into the waveguide combiner 320 and then propagate through the waveguide combiner 320 to reach the user's eye 230. This external light 352 can lead to the presence of rainbow artifacts.

Referring to FIG. 3, the general principle that is followed to ensure a “rainbow” free system is that external light from the world, for example, external light 352 from the external light source 350 incident at any angle on the out-coupler grating 330 in front of the user's eye 230 is not allowed to diffract from the out-coupler grating 330 into the user's eye 230. The limiting case for this artifact is short wavelength light incident on large period gratings. This can be understood by looking at the first order diffraction equation (I):

$$sin ( {θ}_{o u t} ) = sin ( {θ}_{i n} ) + / - \frac{λ}{{Λ}_{OC}} \qquad ( I )$$

where θₒᵤₜ is the angle of light 354 diffracted by the out-coupler grating 330, θᵢₙ is the angle of light 352 incident on the out-coupler grating 330, 2L is the wavelength of light 354, and Λ_{OC} is the period of the out-coupler grating 330. As the wavelength is decreased or the grating period Λ_{OC} is increased, θₒᵤₜ becomes closer to θᵢₙ and the diffracted light 354 therefore becomes closer to the center of the user's field-of-view. However, if the out-coupler grating 330 is designed to have a grating period Λ_{OC} small enough such that all angles of incidence, θᵢₙ, result in diffracted angles θₒᵤₜ, that miss the user's eye 230, then no rainbow artifact is viewable to the user.

Additionally, it is desirable to enable a large field-of-view (FoV) and eyebox plane 220 of the virtual content while also removing the “rainbow” artifact. The maximum FoV of the system can be determined by the substrate index. Inversely, the required minimum substrate refractive index of the waveguide combiner 320 can be determined from a requirement on the FoV.

Effective Out-Coupler Grating Period

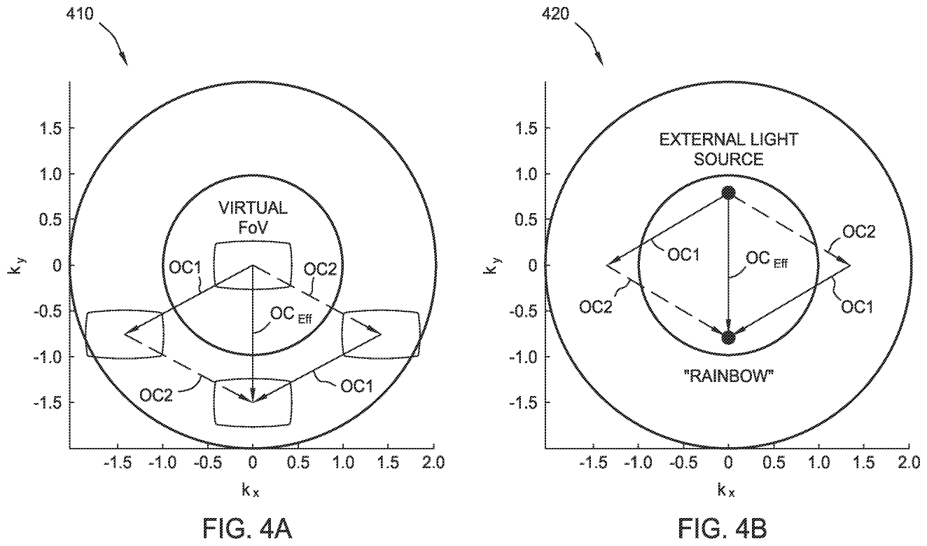

FIG. 4A illustrates a K-Space diagram 410 of a grating vector architecture. FIG. 4B illustrates a K-Space diagram 420 of the grating vector architecture of FIG. 4A including the path of rainbow artifact light. The effective out-coupler grating period is a parameter used in designing a “rainbow” free waveguide combiner. The effective out-coupler grating period is defined as the maximum effective period of all possible diffraction orders which can generate rainbow artifacts in the out-coupling region of the waveguide combiner. The effective out-coupler grating period is easily defined for waveguide combiner grating architectures, which have a single one-dimensional grating in the out-coupling region, and in this case Λ_{OCEff}=Λ_{OC}. However, in more complex waveguide combiner grating architectures there can be two-dimensional or two one-dimensional gratings with different orientation on each surface of the waveguide combiner, which can result in more complex paths of rainbow artifacts. In these cases, it is possible for light to diffract from an external light source into total internal reflection (TIR), then diffract out of TIR by a different grating vector. The sum of these two diffraction events can be a k-vector which is shorter in magnitude than either of the original grating vectors. An example of such a grating vector architecture is shown in FIGS. 4A and 4B. K-Space diagram 410 depicts the path of the virtual FoV, which is the intended image path. K-Space diagram 420 depicts the path of external light diffraction, which is the undesirable rainbow path. The minimum effective grating vector identified for a particular grating architecture can then be used to determine the required periodicities of other gratings in the system in terms of the effective out-coupler grating period, A_{OCEff}.

One example of the “effective” out-coupler grating period AOCeff is as follows. There are rainbow paths which can be generated from the combination of two different physical gratings, but produce rainbow artifacts with output angles consistent with a single “effective” grating period.

If two or more out-coupler grating vectors are present, one should search for combinations of grating vectors (sums), which potentially produce a smaller magnitude grating vector to find Λ_{OCeff}

For example, for two 1D out-coupler gratings:

$${\vec{k}}_{O C 1} = \frac{λ}{{\vec{Λ}}_{O C 1}}$$

$${\vec{k}}_{O C 2} = \frac{λ}{{\vec{Λ}}_{O C 2}}$$

$${\vec{k}}_{eff} = {\vec{k}}_{O C 1} + {\vec{k}}_{O C 2}$$

$$If \vert {\vec{k}}_{eff} \vert < \vert {\vec{k}}_{O C 1} \vert and \vert {\vec{k}}_{eff} \vert < \vert {\vec{k}}_{O C 2} \vert$$

$${\vec{Λ}}_{OCeff} = \frac{λ}{{\vec{k}}_{eff}}$$

Where, \vec{Λ}_{OC1} is the periodicity vector of the first 1D out-coupler, \vec{Λ}_{OC2} is the periodicity vector of second 1D out-coupler, \vec{k}_{OC1} is the grating vector of the first 1D out-coupler, \vec{Λ}_{OC2} the grating vector of the second 1D out-coupler, \vec{k}_{eff} is the effective grating vector of the out-coupler combination, \vec{Λ}_{OCeff} is the effective out-coupler periodicity vector, and λ is a wavelength of light which will cancel out in this calculation.

One example of this type of multiple out-coupler grating configuration is described by FIGS. 4A and 4B.

A variety of options exist for the number of waveguide combiner layers utilized in the “rainbow” free system. In single waveguide layers, three display channels (red, green, blue) propagate through the same layer and diffract from the same grating structures to send the virtual image to the user's eye. In three waveguide-layer systems, each waveguide layer can be designed to support only a single display color channel. Typically, three waveguide-layer systems utilize larger effective out-coupler grating periods, λ_{OCeff}, than single waveguide layer systems because the dedicated Red layer is designed to support only red wavelengths (600-650 nm) instead of also requiring the inclusion of shorter blue wavelengths (430-470 nm).

“Rainbow” free implementations of multi-layer waveguide combiners can be made provided the requirements for the maximum allowable effective out-coupler grating periods, λ_{OCeff}, are held for all of the layers in the system. An advantage of using multiple waveguide layers is that the grating structures can be optimized for the intended display color channel they are designed to support even though the grating periods are limited by the “rainbow” free constraints, which can result in improved color uniformity, luminance uniformity, and efficiency over a single-layer implementation.

Number of Waveguide Combiner Layers

A variety of options exist for the number of waveguide combiner layers utilized in the “rainbow” free system. In single waveguide layers, three display channels (red, green, blue) propagate through the same layer and diffract from the same grating structures to send the virtual image to the user's eye. In three waveguide-layer systems, each waveguide layer can be designed to support only a single display color channel. Typically, three waveguide-layer systems utilize larger effective out-coupler grating periods, Λ_{OCeff}, than single waveguide layer systems because the dedicated Red layer is designed to support only red wavelengths (600-650 nm) instead of also requiring the inclusion of shorter blue wavelengths (430-470 nm).

“Rainbow” free implementations of multi-layer waveguide combiners can be made provided the requirements for the maximum allowable effective out-coupler grating periods, Λ_{OCeff}, are held for all of the layers in the system. One advantage of using multiple waveguide layers is that the grating structures can be optimized for the intended display color channel the grating structures are designed to support even though the grating periods are limited by the “rainbow” free constraints, which can result in improved color uniformity, luminance uniformity, and efficiency over a single-layer implementation.

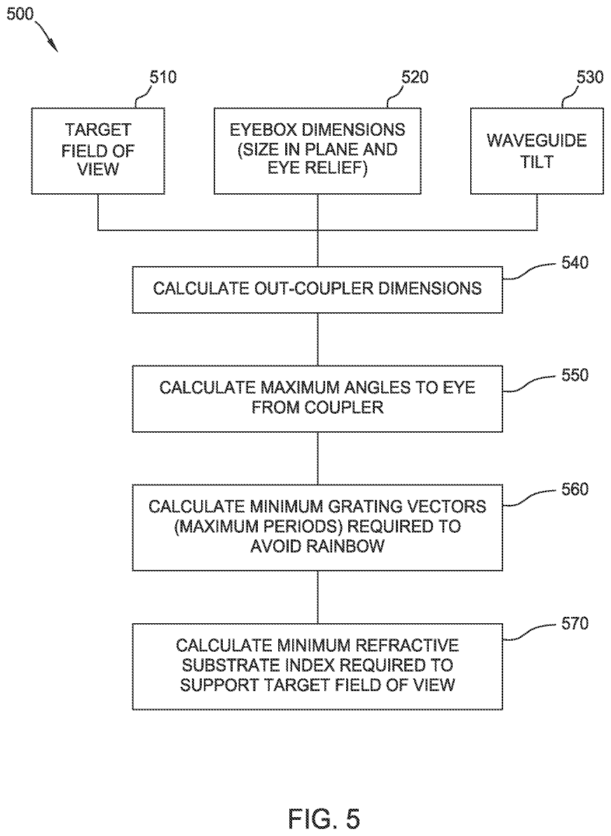

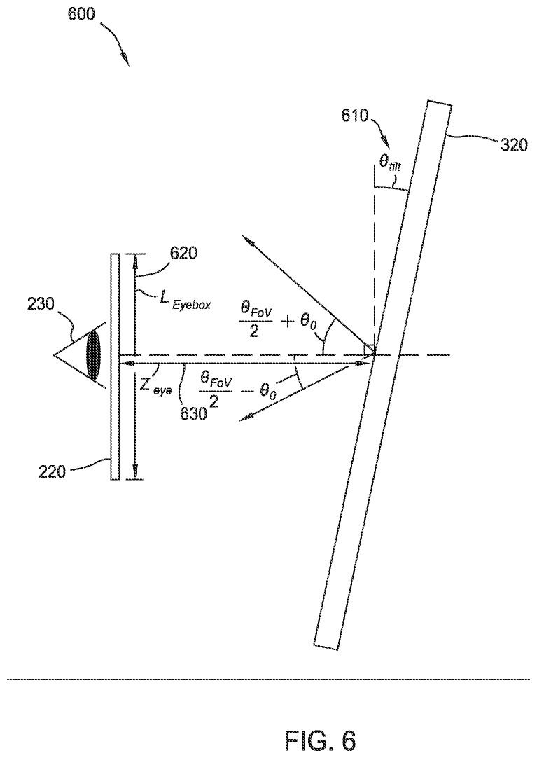

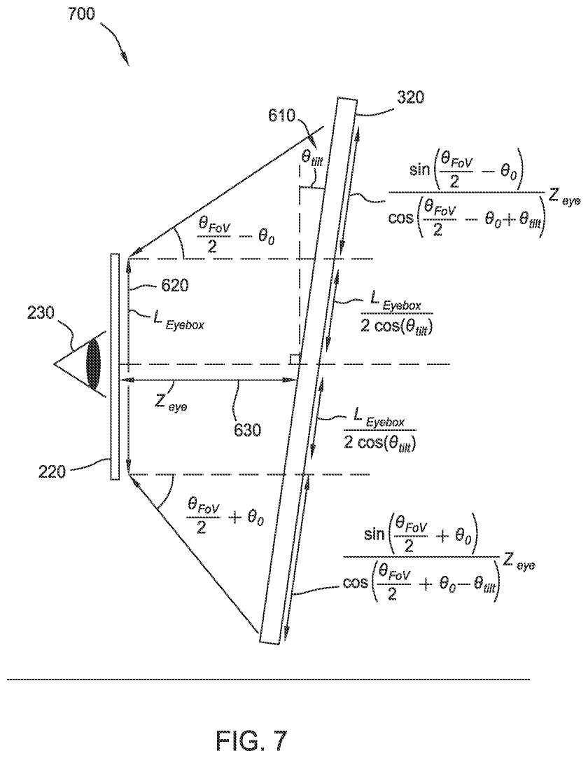

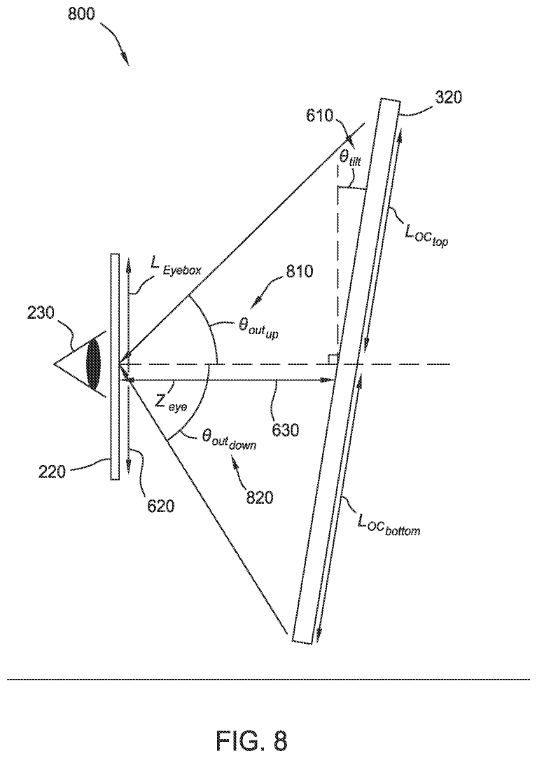

FIG. 5 illustrates a flow chart of a method 500 for determining system design parameters for a rainbow-free waveguide assembly and/or near-eye display system. The method 500 will be discussed in conjunction with FIGS. 6-8. FIG. 6 illustrates various design parameters 600 used in the method 500 depicted by the flow chart of FIG. 5. FIG. 7 illustrates various design parameters used in the method depicted by the flow chart of FIG. 5. FIG. 8 illustrates various design parameters used in the method depicted by the flow chart of FIG. 5.

At operation 510 of the method 500, the target FoV is determined. At operation 520 of the method 500, the eyebox dimensions are determined. At operation 530 of the method 500, the waveguide tilt is determined. The target FoV, the eyebox dimensions, and the waveguide tilt are used as inputs to calculate the out-coupler grating dimensions at operation 540, the maximum angles to the eye from the out-coupler grating at operation 550, the minimum grating vectors (maximum periods) of the out-coupler grating required to avoid the rainbow effect at operation 560, and the minimum substrate index required to support the target FoV at operation 570.

FIG. 6 illustrates various design parameters 600 used in the method 500 depicted by the flow chart of FIG. 5. The field-of-view extent, θ_{Fov}, is considered the axis of the FoV in the direction of the effective out-coupler grating vector, which may be tilted by an amount θ₀. Additionally, the tilt (θₜᵢₗₜ) 610 of the waveguide combiner 320 relative to the eyebox plane 220 is assumed to be along the axis of the effective out-coupler grating vector. L_{Eyebox} 620 is the length of the eyebox plane 220, and z_{eye} 630 is the eye relief distance from the eyebox plane 220 to the waveguide combiner 320.

FIG. 7 illustrates various design parameters 700 used in the method 500 for calculating the dimensions of the out-coupler grating at operation 550. The length of the out-coupler grating is determined using the Target FoV provided at operation 510, the eyebox dimensions provided at operation 520, and the waveguide tilt provided at operation 530. First, the size of the out-coupler to support the eyebox and target FoV is calculated as shown in FIG. 7 using equations (II) and (III).

For equation (II), LOCtop is the length of the top half of the out-coupler grating region.

$${L}_{{OC}_{top}} = \frac{{L}_{Eyebox}}{2 cos ( {θ}_{tilt} )} + \frac{sin ( \frac{{θ}_{FoV}}{2} - {θ}_{0} )}{cos ( \frac{{θ}_{FoV}}{2} - {θ}_{0} + {θ}_{t i l t} )} {z}_{e y e} \qquad ( II )$$

For equation (II), L_{OC}_{ₜₒₚ} bottom is the length of the bottom half of the out-coupler grating region.

$${L}_{{OC}_{b o t t o m}} = \frac{{L}_{Eyebox}}{2 cos ( {θ}_{t i l t} )} + \frac{sin ( \frac{{θ}_{FoV}}{2} + {θ}_{0} )}{cos ( \frac{{θ}_{FoV}}{2} + {θ}_{0} - {θ}_{t i l t} )} {z}_{e y e} \qquad ( III )$$

FIG. 8 illustrates various design parameters 800 used in the method 500 for calculating the maximum angles to the eye from the out-coupler θₒᵤₜ_{ᵤₚ} 810 and θₒᵤₜ_{_{down}} 820 at operation 550. At operation 550, the maximum angles (θₒᵤₜₘₐₓ) from the boundaries of the out-coupler grating to the user's eye are calculated using equation (IV), equation (V), and equation (VI).

$${θ}_{o u {t}_{u p}} < a tan ( \frac{\frac{{L}_{Eyebox}}{2} + {L}_{{OC}_{top}} cos ( {θ}_{tilt} )}{{z}_{eye} + {L}_{{OC}_{top}} sin ( {θ}_{t i l t} )} ) \qquad ( IV )$$

$${θ}_{o u {t}_{down}} < a tan ( \frac{\frac{{L}_{E y e b o x}}{2} + {L}_{{OC}_{b o t t o m}} cos ( {θ}_{t i l t} )}{{z}_{eye} - {L}_{{OC}_{bottom}} sin ( {θ}_{t i l t} )} ) \qquad ( V )$$

$${θ}_{outmax} = {θ}_{{out}_{u p}} + {θ}_{{out}_{d o w n}} \qquad ( VI )$$

For typical system designs, θₒᵤₜ_{_{down}} is generally the limiting case.

At operation 560, the minimum grating vectors (maximum periods) required to avoid the “rainbow” artifact are calculated using the diffraction equation (VII). From the diffraction equation (VII), the effective out-coupler grating period can be related to the maximum output angle calculated at operation 550 using equation (VI).

$${Λ}_{OC} < \frac{{λ}_{0}}{1 + sin ( {θ}_{outmax} )} \qquad ( VII )$$

where λ₀ is the shortest wavelength of “rainbow” artifact considered. In some embodiments, which can be combined with other embodiments, it is assumed that λ₀=450 nm.

At operation 570, the minimum refractive index (n) of the substrate, for example, the waveguide combiner 320, to support the target FoV is calculated. The refractive index (n) of the substrate, for example, the waveguide combiner 320 should be large enough to allow the entire target virtual FoV to propagate in TIR. The limiting case here is the red display channel FoV, due to the longest wavelengths. The minimum refractive index (n) of the substrate is calculated using equation (VIII):

$$n > sin ( \frac{{θ}_{FoV}}{2} - {θ}_{0} + {θ}_{t i l t} ) + \frac{{λ}_{R}}{{Λ}_{OC}} \qquad ( VIII )$$

where n is the waveguide combiner substrate refractive index, and λ_{R} is the wavelength of the red display channel (assumed to be 620 nm for this example).

### EXAMPLES

The following non-limiting examples are provided to further illustrate implementations described herein. However, the examples are not intended to be all inclusive and are not intended to limit the scope of the implementations described herein.

Some example system design parameters which would generate “rainbow” free systems using the equations shown above are shown in Table I below:

TABLE I

| | | | Vir- | | Maximum | Minimum |
|---|---|---|---|---|---|---|
| | | Eye | tual | Layer | Effective | Substrate |
| FoV | Eyebox | Relief | FoV | Tilt | Outcoupler | Refractive |
| (°) | (mm) | (mm) | Tilt | (°) | Period (nm) | Index |
| (θ_{FoV}) | (L_{Eyebox}) | (Z_{eye}) | (θ₀) | (θ_{Tilt}) | (Λ_{OC}) | (n) |
| 10 | 15 | 20 | 0 | 0 | 317 | 2.04 |
| 15 | 15 | 20 | 0 | 0 | 310 | 2.13 |
| 20 | 15 | 20 | 0 | 0 | 303 | 2.22 |
| 25 | 15 | 20 | 0 | 0 | 298 | 2.30 |
| 30 | 15 | 20 | 0 | 0 | 292 | 2.38 |
| 35 | 15 | 20 | 0 | 0 | 287 | 2.46 |
| 40 | 15 | 20 | 0 | 0 | 282 | 2.54 |
| 45 | 15 | 20 | 0 | 0 | 278 | 2.61 |
| 50 | 15 | 20 | 0 | 0 | 274 | 2.69 |
| 10 | 15 | 20 | 10 | 10 | 315 | 2.06 |
| 15 | 15 | 20 | 10 | 10 | 308 | 2.14 |
| 20 | 15 | 20 | 10 | 10 | 302 | 2.23 |
| 25 | 15 | 20 | 10 | 10 | 296 | 2.31 |
| 30 | 15 | 20 | 10 | 10 | 291 | 2.39 |
| 35 | 15 | 20 | 10 | 10 | 286 | 2.47 |
| 40 | 15 | 20 | 10 | 10 | 281 | 2.55 |
| 45 | 15 | 20 | 10 | 10 | 277 | 2.62 |
| 50 | 15 | 20 | 10 | 10 | 273 | 2.69 |

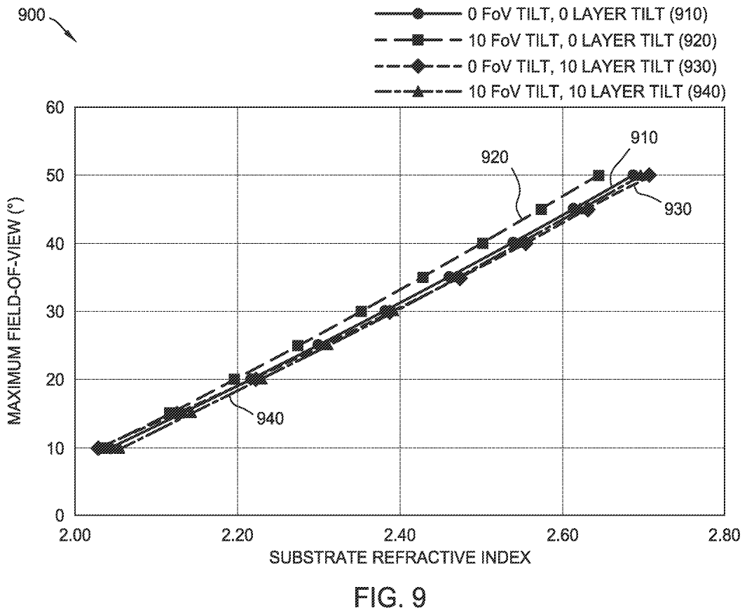

FIG. 9 illustrates a plot 900 depicting Maximum Field of View (°) versus Substrate Refractive Index according to one or more embodiments of the present disclosure. The plot 900 shows the maximum “rainbow” free virtual FoV supported by a substrate refractive index for a 15 mm eyebox at a 20 mm eye relief. Line 910 represents 0 FoV Tilt, 0 Layer Tilt; line 920 represents 10 FoV Tilt, 0 Layer Tilt; line 930 represents 0 FoV Tilt, 10 Layer Tilt; and line 940 represents 10 FoV Tilt, 10 Layer Tilt.

In some embodiments, which can be combined with other embodiments, high index of refraction substrate materials are used to maximize the field-of-view and maintain the ability to design a “rainbow” free system. Examples of these high index of refraction substrate materials include, but are not limited to, high index glasses, as well as transparent crystalline materials (SiC, LiNbO3, LiTaO3, KTaO3, etc.) are good candidates for substrates to utilize in a “rainbow” free diffractive waveguide combiner augmented reality display system.

Implementations can include one or more of the following potential advantages. Utilizing the design relationships and constraints outlined in the present disclosure, the display system described herein does not suffer from external light source diffraction (“rainbow” artifact), in the user's field-of-view. Unlike other approaches to mitigating this artifact, some embodiments described herein do not use any external device or layers to filter the light from sources in the world which is incident on the waveguide-combiner. In addition, some embodiments described herein do not use any visor-like mechanical blockages that extend beyond the plane of the waveguide combiner to prevent light paths that generate “rainbow” artifacts from hitting the waveguide combiner.

Embodiments described herein and all of the functional operations described in this specification can be implemented in digital electronic circuitry, or in computer software, firmware, or hardware, including the structural means disclosed in this specification and structural equivalents thereof, or in combinations of thereof. Embodiments described herein can be implemented as one or more non-transitory computer program products, i.e., one or more computer programs tangibly embodied in a machine readable storage device, for execution by, or to control the operation of, data processing apparatus, e.g., a programmable processor, a computer, or multiple processors or computers.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. Processors suitable for the execution of a computer program include, by way of example, both general and special purpose microprocessors, and any one or more processors of any kind of digital computer.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

When introducing elements of the present disclosure or exemplary aspects or implementation(s) thereof, the articles “a,” “an,” “the” and “said” are intended to mean that there are one or more of the elements.

The terms “comprising,” “including” and “having” are intended to be inclusive and mean that there may be additional elements other than the listed elements.

While the foregoing is directed to embodiments of the present disclosure, other and further implementations of the disclosure may be devised without departing from the basic scope thereof, and the scope thereof is determined by the claims that follow.

1. A method of manufacturing a rainbow-free waveguide display, comprising:
manufacturing a waveguide display assembly configured to direct image light to an eyebox plane having a length (L_{Eyebox}) and to a user's eye, the waveguide display assembly comprising:
a waveguide combiner, and
an out-coupler grating, wherein the out-coupler grating has a grating period Λ_{OC} such that all angles of incidence θᵢₙ of light from an external light source, result in diffracted angles θₒᵤₜ, that miss the user's eye by satisfying the following first order diffraction equation (I):
$$sin ( {θ}_{o u t} ) = sin ( {θ}_{i n} ) + / - \frac{λ}{{Λ}_{OC}} \qquad ( I )$$
wherein λ is the wavelength of the light from the external light source.

2. The method of claim 1, wherein the out-coupler grating has a length (L_{OC}) which is the sum of a length of the top half of the out-coupler grating (L_{OC}_{ₜₒₚ}) and a length of the bottom half of the out-coupler grating (L_{OC}_{_{bottom}}).

3. The method of claim 2, wherein L_{OC}_{ₜₒₚ} is determined using the following equation (II):
$${L}_{{OC}_{top}} = \frac{{L}_{Eyebox}}{2 cos ( {θ}_{tilt} )} + \frac{sin ( \frac{{θ}_{FoV}}{2} - {θ}_{0} )}{cos ( \frac{{θ}_{FoV}}{2} - {θ}_{0} + {θ}_{t i l t} )} {z}_{e y e} \qquad ( II )$$
and L_{OC}_{_{bottom}} is determined using the following equation (III):
$${L}_{{OC}_{b o t t o m}} = \frac{{L}_{Eyebox}}{2 cos ( {θ}_{t i l t} )} + \frac{sin ( \frac{{θ}_{FoV}}{2} + {θ}_{0} )}{cos ( \frac{{θ}_{FoV}}{2} + {θ}_{0} - {θ}_{t i l t} )} {z}_{e y e} \qquad ( III )$$
wherein the field-of-view extent, θ_{FoV}, is the axis of the FoV in the direction of the effective out-coupler grating vector, which can be tilted by an amount (θ₀), (θₜᵢₗₜ) is the tilt of the waveguide combiner relative to a plane defined by the eyebox plane, and the waveguide combiner is positioned a first distance z_{eye}, from the eyebox plane.

4. The method of claim 3, wherein maximum angles (θₒᵤₜₘₐₓ) from the boundaries of the out-coupler grating to the user's eye are determined using equation (IV), equation (V), and equation (VI).
$${θ}_{o u {t}_{up}} < atan ( \frac{\frac{{L}_{Eyebox}}{2} + {L}_{{OC}_{top}} cos ( {θ}_{tilt} )}{{z}_{eye} + {L}_{{OC}_{top}} sin ( {θ}_{tilt} )} ) \qquad ( IV )$$
$${θ}_{o u {t}_{down}} < atan ( \frac{\frac{{L}_{Eyebox}}{2} + {L}_{{OC}_{bottom}} cos ( {θ}_{tilt} )}{{z}_{eye} - {L}_{{OC}_{bottom}} sin ( {θ}_{tilt} )} ) \qquad ( V )$$
$${θ}_{out max} = {θ}_{o u {t}_{up}} + {θ}_{o u {t}_{down}} . \qquad ( VI )$$

5. The method of claim 4, wherein the out-coupler grating has a maximum period satisfying the following equation (VII):
$${Λ}_{OC} < \frac{{λ}_{0}}{1 + sin ( {θ}_{out max} )} \qquad ( VII )$$
where λ₀ is the shortest wavelength of “rainbow” artifact considered.

6. The method of claim 5, wherein λ₀ is 450 nm.

7. The method of claim 5, wherein the waveguide combiner has a minimum refractive index (n) satisfying the following equation (VIII):
$$n > sin ( \frac{{θ}_{F o V}}{2} - {θ}_{0} + {θ}_{tilt} ) + \frac{{λ}_{R}}{{Λ}_{OC}} \qquad ( VIII )$$
where λ_{R} is the wavelength of the red display channel.

8. The method of claim 7, wherein λ_{R} is 620 nm.

9. A waveguide display, comprising:
the waveguide display configured to direct image light to an eyebox plane having a length (L_{Eyebox}) and to a user's eye, the waveguide display, comprising:
a waveguide combiner, and
an out-coupler grating, wherein the out-coupler grating has a grating period Λ_{OC} such that all angles of incidence θᵢₙ of light from an external light source, result in diffracted angles θₒᵤₜ, that miss the user's eye by satisfying the following first order diffraction equation (I):
$$sin ( {θ}_{out} ) = sin ( {θ}_{i n} ) + / - \frac{λ}{{Λ}_{OC}} \qquad ( I )$$
wherein A is the wavelength of the light from the external light source.

10. The waveguide display of claim 9, wherein the out-coupler grating has a length L_{OC}) which is the sum of a length of the top half of the out-coupler grating (L_{OC}_{ₜₒₚ}) and a length of the bottom half of the out-coupler grating (L_{OC}_{_{bottom}}).

11. The waveguide display of claim 10, wherein L_{OC}_{ₜₒₚ} is determined using the following equation (II):
$${L}_{{OC}_{top}} = \frac{{L}_{Eyebox}}{2 cos ( {θ}_{t i l t} )} + \frac{sin ( \frac{{θ}_{F o V}}{2} - {θ}_{0} )}{cos ( \frac{{θ}_{F o V}}{2} - {θ}_{0} + {θ}_{tilt} )} {z}_{e y e} \qquad ( II )$$
and L_{OC}_{_{bottom}} is determined using the following equation (III):
$${L}_{{OC}_{bottom}} = \frac{{L}_{Eyebox}}{2 cos ( {θ}_{t i l t} )} + \frac{sin ( \frac{{θ}_{F o V}}{2} + {θ}_{0} )}{cos ( \frac{{θ}_{F o V}}{2} + {θ}_{0} - {θ}_{tilt} )} {z}_{e y e} \qquad ( III )$$
wherein the field-of-view extent, θ_{FoV}, is the axis of the FoV in the direction of the effective out-coupler grating vector, which can be tilted by an amount (θ₀), (θₜᵢₗₜ) is the tilt of the waveguide combiner relative to a plane defined by the eyebox plane, and the waveguide combiner is positioned a first distance z_{eye} from the eyebox plane.

12. The waveguide display of claim 11, wherein maximum angles (θₒᵤₜₘₐₓ) from the boundaries of the out-coupler grating to the user's eye are determined using equation (IV), equation (V), and equation (VI).
$${θ}_{o u {t}_{up}} < atan ( \frac{\frac{{L}_{Eyebox}}{2} + {L}_{{OC}_{top}} cos ( {θ}_{tilt} )}{{z}_{eye} + {L}_{{OC}_{top}} sin ( {θ}_{tilt} )} ) \qquad ( IV )$$
$${θ}_{o u {t}_{down}} < atan ( \frac{\frac{{L}_{Eyebox}}{2} + {L}_{{OC}_{bottom}} cos ( {θ}_{tilt} )}{{z}_{eye} - {L}_{{OC}_{bottom}} sin ( {θ}_{tilt} )} ) \qquad ( V )$$
$${θ}_{out max} = {θ}_{o u {t}_{up}} + {θ}_{o u {t}_{down}} . \qquad ( VI )$$

13. The waveguide display of claim 12, wherein the out-coupler grating has a maximum period satisfying the following equation (VII):
$${Λ}_{OC} < \frac{{λ}_{0}}{1 + sin ( {θ}_{out max} )} \qquad ( VII )$$
where λ₀ is the shortest wavelength of “rainbow” artifact considered.

14. The waveguide display of claim 13, wherein λ₀ is 450 nm.

15. The waveguide display of claim 13, wherein the waveguide combiner has a minimum refractive index (n) satisfying the following equation (VIII):
$$n > sin ( \frac{{θ}_{F o V}}{2} - {θ}_{0} + {θ}_{tilt} ) + \frac{{λ}_{R}}{{Λ}_{OC}} \qquad ( VIII )$$
where λ_{R} is the wavelength of the red display channel.

16. The waveguide display of claim 15, wherein λ_{R} is 620 nm.

17. A near-eye display, comprising:
a frame; and
a display, comprising:
a waveguide display configured to direct image light to an eyebox plane having a length (L_{Eyebox}) and to a user's eye, the waveguide display, comprising:
a waveguide combiner, and
an out-coupler grating, wherein the out-coupler grating has a grating period Λ_{OC} such that all angles of incidence θᵢₙ of light from an external light source, result in diffracted angles θₒᵤₜ, that miss the user's eye by satisfying the following first order diffraction equation (I):
$$sin ( {θ}_{o u t} ) = sin ( {θ}_{i n} ) + / - \frac{λ}{{Λ}_{o c}} \qquad ( I )$$
wherein λ is the wavelength of the light from the external light source.

18. The near-eye display of claim 17, wherein the out-coupler grating has a length L_{OC}) which is the sum of a length of the top half of the out-coupler grating (L_{OC}_{ₜₒₚ}) and a length of the bottom half of the out-coupler grating (L_{OC}_{_{bottom}}).

19. The near-eye display of claim 18, wherein L_{OC}_{ₜₒₚ} is determined using the following equation (II):
$${L}_{{OC}_{top}} = \frac{{L}_{Eyebox}}{2 cos ( {θ}_{t i l t} )} + \frac{sin ( \frac{{θ}_{F o V}}{2} - {θ}_{0} )}{cos ( \frac{{θ}_{F o V}}{2} - {θ}_{0} + {θ}_{tilt} )} {z}_{e y e} \qquad ( II )$$
and L_{OC}_{_{bottom}} is determined using the following equation (III):
$${L}_{{OC}_{bottom}} = \frac{{L}_{Eyebox}}{2 cos ( {θ}_{t i l t} )} + \frac{sin ( \frac{{θ}_{F o V}}{2} + {θ}_{0} )}{cos ( \frac{{θ}_{F o V}}{2} + {θ}_{0} - {θ}_{tilt} )} {z}_{e y e} \qquad ( III )$$
wherein the field-of-view extent, θ_{FoV}, is the axis of the FoV in the direction of the effective out-coupler grating vector, which can be tilted by an amount (θ₀), (θₜᵢₗₜ) is the tilt of the waveguide combiner relative to a plane defined by the eyebox plane, and the waveguide combiner is positioned a first distance z_{eye} from the eyebox plane.

20. The near-eye display of claim 19,
wherein maximum angles (θₒᵤₜₘₐₓ) from the boundaries of the out-coupler grating to the user's eye are determined using equation (IV), equation (V), and equation (VI).
$${θ}_{o u {t}_{up}} < atan ( \frac{\frac{{L}_{Eyebox}}{2} + {L}_{{OC}_{top}} cos ( {θ}_{tilt} )}{{z}_{eye} + {L}_{{OC}_{top}} sin ( {θ}_{tilt} )} ) \qquad ( IV )$$
$${θ}_{o u {t}_{down}} < atan ( \frac{\frac{{L}_{Eyebox}}{2} + {L}_{{OC}_{bottom}} cos ( {θ}_{tilt} )}{{z}_{eye} - {L}_{{OC}_{bottom}} sin ( {θ}_{tilt} )} ) \qquad ( V )$$
$${θ}_{out max} = {θ}_{o u {t}_{up}} + {θ}_{o u {t}_{down}} ; \qquad ( VI )$$
wherein the out-coupler grating has a maximum period satisfying the following equation (VII):
$${Λ}_{OC} < \frac{{λ}_{0}}{1 + sin ( {θ}_{out max} )} \qquad ( VII )$$
where λ₀ is the shortest wavelength of “rainbow” artifact considered;
wherein λ₀ is 450 nm;
wherein the waveguide combiner has a minimum refractive index (n) satisfying the following equation (VIII):
$$n > sin ( \frac{{θ}_{F o V}}{2} - {θ}_{0} + {θ}_{tilt} ) + \frac{{λ}_{R}}{{Λ}_{OC}} \qquad ( VIII )$$
where λ_{R} is the wavelength of the red display channel; and
wherein λ_{R} is 620 nm.
